(19) United States
(12) Patent Application Publication
(10) Pub. No.: US 2015/0039673 A1
(43) Pub. Date: Feb. 5, 2015

(54) IMAGE PROCESSING SYSTEM AND RECORDING MEDIUM

(71) Applicant: Tomoki SHIBUKAWA, Kanagawa (JP)

(72) Inventor: Tomoki SHIBUKAWA, Kanagawa (JP)

(73) Assignee: RICOH COMPANY, LTD., Tokyo (JP)

(21) Appl. No.: 14/331,418

(22) Filed: Jul. 15, 2014

(30) Foreign Application Priority Data
Aug. 5, 2013 (JP) 2013-162297

(51) Int. Cl. H04L 29/08

(52) U.S. Cl. CPC H04L 67/12
USPC 709/202

(57) ABSTRACT

An image processing system includes an image processing apparatus configured to process an image, a detector configured to detect occurrence of a disaster, a first generator configured to generate information indicating locations of staff members belonging to an office where the image processing apparatus is placed when the detector has detected the occurrence of the disaster, and a first transmitter configured to transmit the information indicating the locations generated by the first generator to a predetermined transmission destination according to the office.

### BACKGROUND OF THE INVENTION

1. Field of the Invention

The disclosures herein generally relate to an image processing system and a non-transitory recording medium storing a program.

2. Description of the Related Art

There are systems known in the art that generate and send information for confirming safety of disaster victims when a disaster has occurred (e.g., Patent Document 1). In addition, there are proposed image processing apparatuses such as multifunction peripherals that may be applied to construct such systems (e.g., Patent Documents 2 to 4). The application of the image processing systems such as multifunction peripherals may be suitable for creating and sending various types of information when an emergency arises because those apparatuses are connected to networks and power of those are usually turned on.

However, predetermined administrators of these related art systems to which the image processing apparatuses are applied generally need to manually input data to generate, for example, information for use in safety confirmation. Thus, it may be difficult to confirm safety of disaster victims even with the related art systems in such a chaotic situation where a disaster has occurred.

### RELATED ART DOCUMENTS

### Patent Documents

### [Patent Document 1] Japanese Laid-open Patent Publication No. 2006-11721

### [Patent Document 2] Japanese Laid-open Patent Publication No. 05-145688

### [Patent Document 3] Japanese Laid-open Patent Publication No. 2008-172406

### [Patent Document 4] Japanese Laid-open Patent Publication No. 2009-237607

### SUMMARY OF THE INVENTION

In one aspect of an embodiment, it may be desired to construct a system that facilitates confirmation of safety of disaster victims.

According to an embodiment, there is provided an image processing system that includes an image processing apparatus configured to process an image, a detector configured to detect occurrence of a disaster, a first generator configured to generate information indicating locations of staff members belonging to an office where the image processing apparatus is placed when the detector has detected the occurrence of the disaster, and a first transmitter configured to transmit the information indicating the locations generated by the first generator to a predetermined transmission destination according to the office.

Other objects, features and advantages of the present invention will become more apparent from the following detailed description when read in conjunction with the accompanying drawings.

### BRIEF DESCRIPTION OF THE DRAWINGS

FIG. 1 is a diagram illustrating a functional configuration of an image processing apparatus according to an embodiment, and a configuration of an image processing system to which the image processing apparatus is applied;

FIG. 2 is a diagram illustrating an example of employees' information in an employees' information management database apparatus according to an embodiment;

FIG. 3 is another diagram illustrating an example of employees' information in an employees' information management database apparatus according to an embodiment;

FIG. 4 is a flowchart illustrating an information generating-transmitting process by an image processing apparatus according to an embodiment;

FIG. 5 is a diagram illustrating an example of an attendance information list generated by an image processing apparatus according an embodiment;

FIG. 6 is a diagram illustrating an example of location information generated by an image processing apparatus according an embodiment;

FIG. 7 is a diagram illustrating another example of location information generated by an image processing apparatus according an embodiment;

FIG. 8 is a flowchart illustrating another information generating-transmitting process by an image processing apparatus according to an embodiment;

FIG. 9 is a flowchart illustrating another information generating-transmitting process by an image processing apparatus according to an embodiment; and

FIG. 10 is a diagram illustrating another example of location information generated by an image processing apparatus according an embodiment.

### DETAILED DESCRIPTION OF THE PREFERRED EMBODIMENTS

In the following, a description is given of embodiments of the present invention with reference to the accompanying drawings. Note that duplicated descriptions may be omitted by assigning identical reference numerals to those components having substantially the same functional configurations in the specification and the drawings of the present application.

### First Embodiment

### Functional Configuration of Image Processing Apparatus

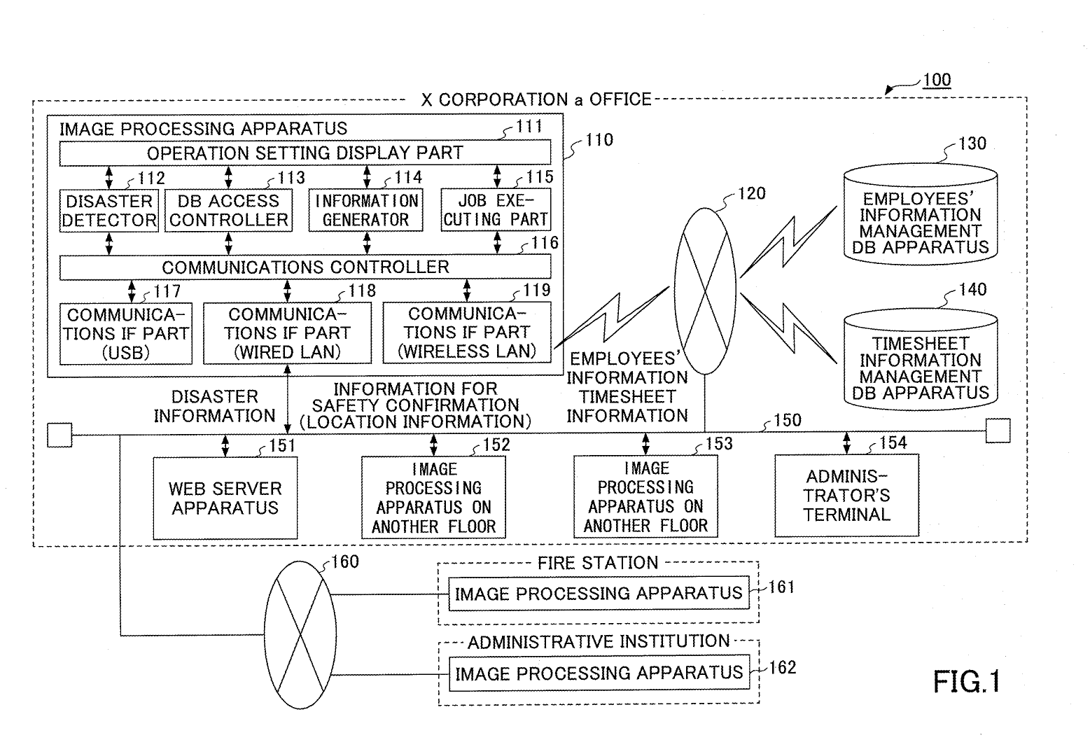

First of all, a description is given of a functional configuration of an image processing apparatus 110 according to a first embodiment with reference to FIG. 1. FIG. 1 is a diagram illustrating a functional configuration of the image processing apparatus 110 according to the embodiment, and a system configuration of an image processing system 100 to which the image processing apparatus 110 is applied.

In the image processing apparatus 110 of FIG. 1, an operation setting display part 111 is configured to serve as a user interface to display setting screens for various settings and receive various setting operations from a user.

A disaster detector 112 is configured to detect disasters. Note that the disasters in this context may include any disasters such as earthquakes, fires, tidal waves, tornadoes, typhoons, and earth-flow disasters. The disaster detector 112 may be configured to detect an emergency command to warn people of the occurrence of a disaster, which is generated by depression of an emergency button (switch). Further, the disaster detector 112 may be connected to measurement hardware such as a seismometer or an oscillometer, such that the disaster detector 112 may be configured to detect the occurrence of a disaster when the output of the measurement hardware reaches a predetermined value or above. Alternatively, the disaster detector 112 may be configured to detect the occurrence of a disaster by receiving via networks disaster information provided by the government, local authorities, and external organizations such as companies.

A database (DB) access controller 113 is configured to access to later-described employees' information management database (DB) apparatus 130 and timesheet information management database (DB) apparatus 140 when the disaster detector 112 has detected a disaster. The (DB) access controller 113 is also configured to acquire employees' information and timesheet information.

An information generator 114 is configured to generate information for safety confirmation (location information) based on the employee's information and the timesheet information that are acquired by the database (DB) access controller 113 that accesses the employees' information management DB apparatus 130 and timesheet information management DB apparatus 140.

A job executing part 115 is configured to control a plotter and a scanner device of the image processing apparatus 110 and execute various types of jobs including print jobs.

A communications controller 116 is configured to forward various types of information received via communication IF parts 117 to 119 to the disaster detector 112, the DB access controller 113, or a job executing part 115. Further, the communications controller 116 is also configured to forward to the communications IF parts 117 to 119 various types of information including commands output via the DB access controller 113, the information generator 114, and the job executing part 115.

The communications IF part 117 is a communications device configured to perform communications via a universal serial bus (USB) connection. Similarly, the communications IF part 118 is a communications device configured to perform communications by being connected to a wired local area network (LAN) 150. Further, the communications IF part 119 is a communications device configured to perform communications by being connected to a wireless local area network (LAN) 120.

Note that in the image processing apparatus 110, communications may performed with external apparatuses by being connected to the USB, the wired LAN 150 connection, and the wireless LAN 120. Hence, the communications IF parts 117 to 119 are disposed in the image processing apparatus 110. However, the image processing apparatus 110 is not limited to the above configuration. The image processing apparatus 110 may further include communications IF parts configured to perform communications via a serial bus, Bluetooth (registered trademark), IrDA, and the like.

Note that components of the image processing apparatus 110 may be implemented by causing a not-illustrated computer to execute a program or implemented by hardware.

### Configuration of Image Processing System

Next, a description is given, with reference to FIGS. 1 to 3, of a configuration of an image processing system 100 to which the image processing apparatus 110 according to the first embodiment is applied.

As illustrated in FIG. 1, in the image processing system 100 of the “a Office” of the “X corporation” where the image processing apparatus 110 is placed, the wireless LAN 120 is constructed, and the communications IF part (the wireless LAN) 119 of the image processing apparatus 110 is connected to the wireless LAN 120.

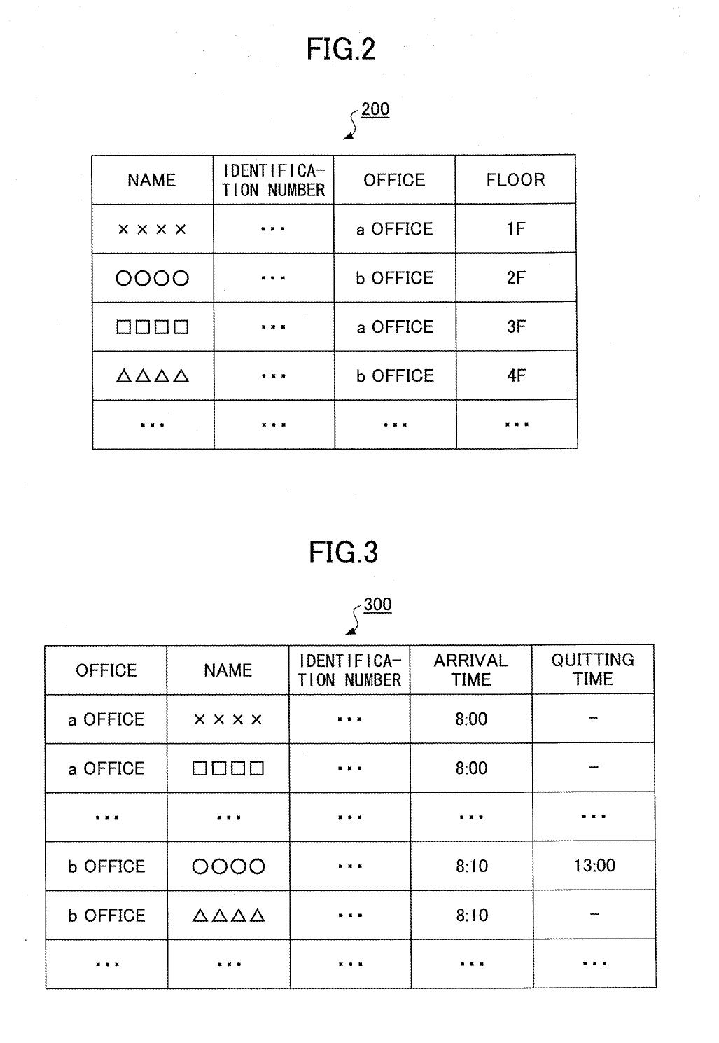

Further, in the image processing system 100, the employees' information management DB apparatus 130 that manages attributes of the employees (staff members) who belong to the “X corporation” is disposed, and the employees' information management DB apparatus 130 is also connected to the wireless LAN 120. Note that FIG. 2 is a diagram illustrating an example of employees' information 200 managed by the employees' information management DB apparatus 130. As illustrated in FIG. 2, the employees' information 200 at least includes names of all the employees who belong to the “X corporation”, a unique identification number specifying each employee, an “office” indicating his or her workplace where each employee works, a floor of the “office” where each employee stays, and the like.

Further, in the image processing system 100, the timesheet information management DB apparatus 140 that manages timesheet data of all the employees who belong to the “X corporation” is disposed, and the timesheet information management DB apparatus 140 is also connected to the wireless LAN 120. Note that FIG. 3 is a diagram illustrating an example of timesheet information 300 managed by the timesheet information management DB apparatus 140. As illustrated in FIG. 3, the timesheet information 300 at least includes a name of each employee who belongs to a corresponding office, a unique identification number specifying each employee, an “arrival time” at which each employee arrives at the corresponding office, a quitting time at which each employee quits the office, and the like.

The following description is given by referring back to FIG. 1. As illustrated in FIG. 1, the image processing system 100 of the “a Office” of the X corporation further includes the wired LAN 150, and the image processing apparatus 110 is connected to the wired LAN 150 via the communications IF part (for the wired LAN) 118. An external network 160 is further connected to the wired LAN 150. Hence, the communication IF part (for the wired LAN) 118 may be able to receive disaster information that is transmitted via the external network 160.

In addition, a WEB server apparatus 151, image processing apparatuses 152 and 153 on other floors, and an administrator's terminal 154 for an administrator (manager) who presides over the “a Office” are also connected to the wired LAN 150.

The WEB server apparatus 151 is configured to be accessed via the external network 160. The WEB server apparatus 151 may provide a homepage of the “a Office”, for example. An external user may use his or her own terminal (not illustrated) to access the WEB server apparatus 151 via the external network 160 to browse the homepage of the “a Office”.

The image processing apparatuses 152 and 153 on other floors indicate image processing apparatuses on the second floor (2F) and the third floor (3F) when the image processing apparatus 110 is placed on the first floor (1F) of the “a Office”. The image processing apparatuses 152 and 153 on other floors at least include functional components similar to the job executing part 115 of the image processing apparatus 110. Hence, the image processing apparatuses 152 and 153 on other floors may be able to execute print jobs transmitted from the image processing apparatus 110 to print out the print jobs.

The administrator's terminal 154 is a terminal that is owned by the administrator (manager) of the “a Office”. Note that FIG. 1 illustrates an example where the administrator's terminal 154 is connected to the wired LAN 150. However, the administrator's terminal 154 may be configured to be connected to the wireless LAN 120 or to the external network 160.

Further, image processing apparatuses 161 and 162 placed in an administrative agency (a fire station or an administrative institution) that manages an area (called an “A-area”) including the “a Office” are connected to the external network 160 to which the wired LAN 150 is connected. Hence, the image processing apparatus 161 inside the fire station or the image processing apparatus 162 inside the administrative institution may be able to print out information transmitted by the image processing apparatus 110.

### Information Generating-Transmitting Process in Image Processing Apparatus

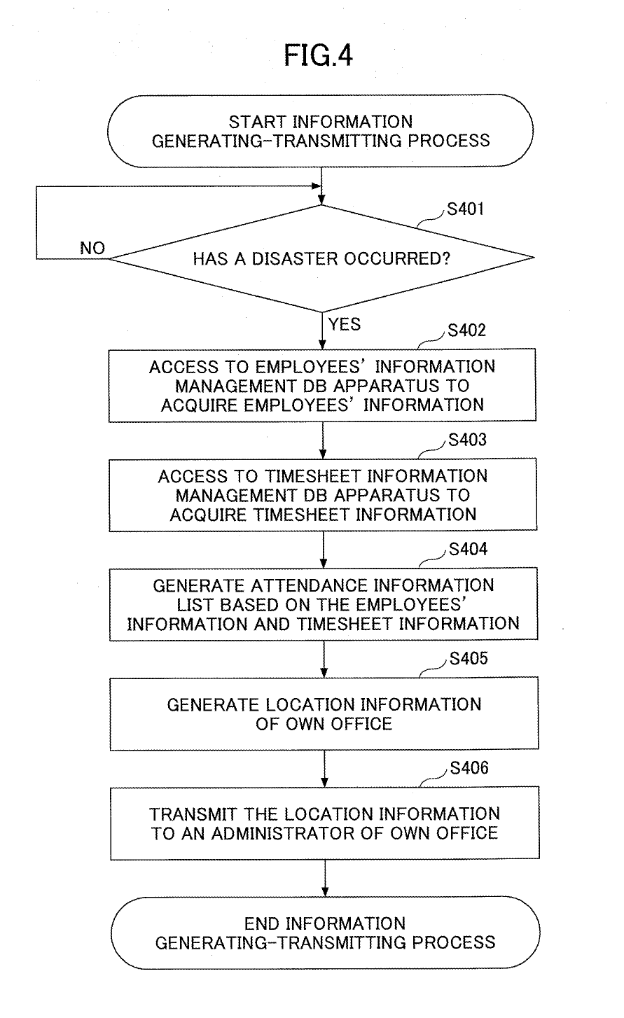

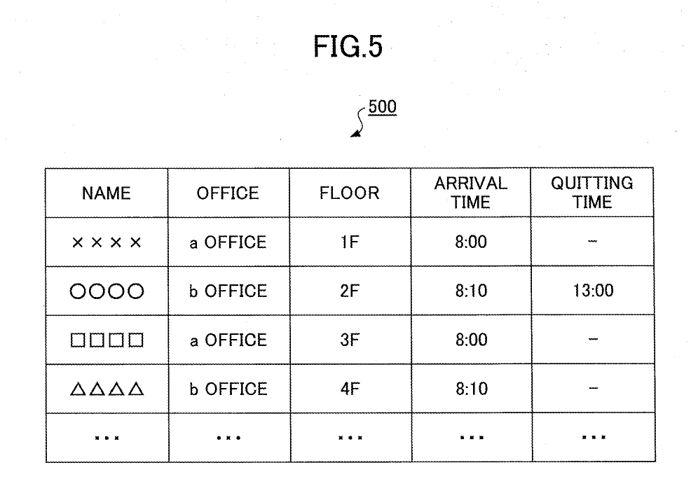

Next, an illustration is given of an information generating-transmitting process of the image processing apparatus 110 when a disaster has occurred. FIG. 4 is a flowchart illustrating the information generating-transmitting process of the image processing apparatus 110. Note that in the first embodiment, the information generating-transmitting process of the image processing apparatus 110 illustrated as the flowchart of FIG. 4 is implemented by causing a central processing unit (CPU) to load a program (for implementing respective functions of the disaster detector 112, the DB access controller 113, the information generator 114, and the communications controller 116) stored in a storage device in memory and execute the loaded program. Note that activation of the image processing apparatus 110 by receiving power may automatically start the information generating-transmitting process of the image processing apparatus 110.

As illustrated in FIG. 4, when the information generating-transmitting process starts, the disaster detector 112 monitors whether a disaster has occurred in step S401. When the disaster detector 112 determines that no disaster has occurred, the disaster detector 112 remains in a standby mode until the disaster detector 112 detects the occurrence of a disaster. On the other hand, when the disaster detector 112 detects the occurrence of a disaster, step S402 is processed.

Note that, as described above, the disaster detector 112 may be configured to detect an emergency command to warn people of the occurrence of a disaster, which is generated by depressing an emergency button (switch). Further, the disaster detector 112 may be connected to measurement hardware such as a seismometer or an oscillometer, such that the disaster detector 112 may be configured to detect the occurrence of a disaster when the output of the measurement hardware reaches a predetermined value or above. Alternatively, the disaster detector 112 may be configured to detect the occurrence of a disaster by receiving via networks disaster information provided by the government, local authorities, and external organizations such as companies.

When the occurrence of a disaster is detected and step S402 is processed, the DB access controller 113 accesses the employees' information management DB apparatus 130 via the communications IF part (wireless LAN) 119 to acquire employees' information 200 that is illustrated as an example in FIG. 2. Thus, in the image processing apparatus 110, it may be possible to acquire the latest employees' information 200 at the occurrence of a disaster by accessing the employees' information management DB 130 using the detection of the occurrence of a disaster as a trigger.

Further, in step S403, the DB access controller 113 accesses the timesheet information management DB apparatus 140 via the communications IF part (wireless LAN) 119 to acquire timesheet information 300 that is illustrated as an example in FIG. 3. Thus, in the image processing apparatus 110, it may be possible to acquire the latest timesheet information 300 at the occurrence of a disaster by accessing the timesheet information management DB 140 using the detection of the occurrence of a disaster as a trigger.

In step S404, the information generator 114 generates an attendance information list 500 based on the employees' information 200 acquired in step S402 and the timesheet information 300 acquired in step S403. The attendance information list 500 illustrates timesheet information in respective assigned floors of workplaces of all the employees who belong to “X Corporation”. FIG. 5 is a diagram illustrating an example of the attendance information list 500 that is generated in step S404.

As illustrated in FIG. 5, the attendance information list 500 includes at least a “name” of each employee, an “office” of his/her workplace, and a staying “floor” of the office at his/her workplace that are recorded in the acquired latest employees' information. Further, the attendance information list 500 includes an “arrival time” and a “quitting time” of each employee at his/her corresponding office recorded in the latest acquired timesheet information 300.

In step S405, the information generator 114 generates information (location information) for safety confirmation in an own office (an office where the image processing apparatus 110 is placed) based on the attendance information list 500 that is generated in step S404.

The location information indicates a list of the employees who actually stayed at the office that has faced a disaster. The image processing apparatus 110 according to the first embodiment is placed in “a Office”. Hence, when generating location information, the information generator 114 initially extracts employees who belong to “a Office” from the already generated attendance information list 500. Subsequently, the information generator 114 extracts the employees who actually stayed in the “a Office” at the occurrence of a disaster from the employees who belong to the “a Office”, which excludes the employees who had already departed from the “a Office” at the occurrence of the disaster. Further, the information generator 114 lists as transmission destinations of the location information the image processing apparatuses 161 and 162 placed in an administrative agency that manages the “a Office” (i.e., a fire station or an administrative institution that manages the “a Office” in the first embodiment).

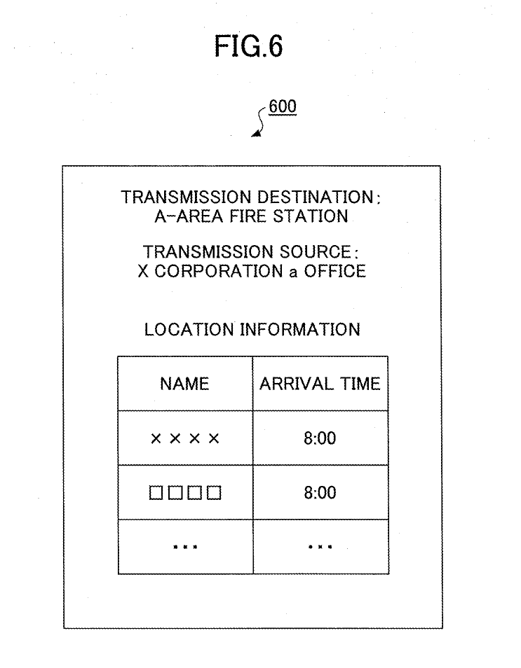

FIG. 6 is a diagram illustrating an example of location information 600 that is generated in step S405. As illustrated in FIG. 6, as a result of step S405, the location information 600 lists as a transmission destination an A-area fire station that manages an “A-area”where the “a Office” is located and as a transmission source (i.e., a sender) “a Office” of the “X Corporation” where the image processing apparatus 110 is placed.

Further, the location information 600 lists employees who belong to the “a Office” and had stayed inside the “a Office” (i.e., who had already arrived at the a Office and had not departed from the a Office) when a disaster occurred.

In step S406, the communications controller 116 transmits the location information 600 generated in step S405 to the image processing apparatus 161 in the A-area fire station that manages the “A-area” where the “a Office” resides. Hence, the A-area fire station may be capable of accurately grasping which employees are subject to safety confirmation. As a result, the A-area fire station may be able to efficiently organize a rescue operation when a disaster has occurred.

Note that the transmission destination of the location information is not necessarily limited to the “A-area fire station”. The location information may be transmitted to the A-area administration institution that manages the “A-area”. Hence, the A-area administrative institution may also be capable of accurately grasping which employees are subject to safety confirmation. As a result, the administrative institution may be capable of grasping the accurate number of people for preparing material supplies and the like when a disaster has occurred.

When the location information has been transmitted in step S406, the information generating-transmitting process ends. Note that the information generating-transmitting process may be configured to be repeatedly executed until the image processing apparatus 110 is turned off. Alternatively, the information generating-transmitting process may be configured to end temporarily when the location information has been transmitted and restart when the image processing apparatus 110 is rebooted.

### SUMMARY

As described above, the image processing apparatus 110 according to the first embodiment is:
configured to include the disaster detector 112 to detect the occurrence of a disaster,
configured to access the employees' information management DB apparatus 130 and the timesheet information management DB apparatus 140 to initially generate the latest attendance information list and subsequently generate the location information, and
configured to automatically transmit the generated information to the image processing apparatus of the administrative agency (e.g., a fire station or an administrative institution) that manages an office where own apparatus is placed.

As described above, in the image processing apparatus 110 according to the first embodiment, it may be possible to generate the latest attendance information list by accessing the existing database apparatuses (the employees' information management DB apparatus 130 and the timesheet information management DB apparatus 140). Thus, unlike the related art system, there may be no need to dispose a dedicated sensor (i.e., a sensor for generating information for use in safety confirmation, e.g., a sensor to detect people's presence or absence or entering and leaving a room) in the image processing apparatus 110 according to the first embodiment. Hence, it may be possible to construct the image processing system having the image processing apparatus 110 according to the first embodiment at low cost.

Further, in the image processing apparatus 110 according to the first embodiment, the employees who belong to the own office and stay in the own office when a disaster has occurred are automatically extracted based on the generated attendance information list. Hence, it may be possible to reliably generate the location information in such a chaotic situation where a disaster has occurred. Moreover, in the image processing apparatus 110 according to the first embodiment, the location information does not include information unnecessary for safety confirmation (e.g., employees who belong to another office or who did not stay in the own office when a disaster occurred). Hence, it may be possible to efficiently and reliably confirm safety of the employees who belong to the own office and stay in the own office when a disaster has occurred.

In addition, in the image processing apparatus according to the first embodiment, the generated location information may be automatically transmitted to the image processing apparatus that is placed in the administrative agency of the own office (e.g., a fire station or administrative institution that manages the own office) as the transmission destination. Hence, the administrative agency may be able to reliably acknowledge the location information by causing the image processing apparatus as the transmission destination to print the location information. Thus, the external third party will not fail to read the generated information.

In summary, according to the first embodiment, it may be possible to construct a system that easily implements safety confirmation of disaster victims.

### Second Embodiment

In the configuration of the first embodiment, a description is given of a case where the administrative agency (e.g., a fire station or an administrative institution) that manages the “a Office” where the image processing apparatus 110 is placed performs safety confirmation of the employees. However, the invention is not limited to the first embodiment. For example, an employee who belongs to the “a Office” and serves as an administrator (a manager) who presides over the “a Office” may perform safety confirmation.

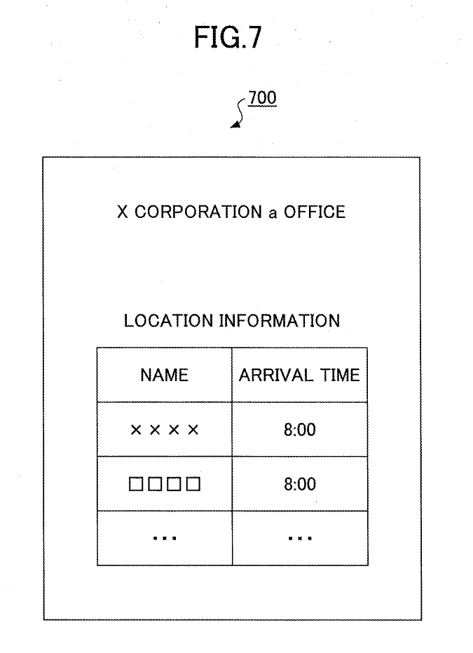

In this case, the location information generated in step S405 is transmitted to the administrator's terminal 154. Hence, the administrator (the manager) who presides over the “a Office” may be able to confirm safety of the employees of the “a Office” by displaying the location information on the administrator's terminal 154. Note that FIG. 7 is a diagram illustrating an example of location information 700 that is transmitted to the administrator's terminal 154. The location information 700 illustrated in FIG. 7 is used by the administrator (manager) who presides over the “a Office” when the administrator performs safety confirmation. Hence, the location information 700 includes a list of offices that are subject to safety confirmation.

### Third Embodiment

In the configurations of the first and the second embodiments, a subject that performs safety confirmation (the fire station, the administrative institution, or the administrator who presides over the “a Office”) is determined in advance and the location information is automatically transmitted to this predetermined subject. However, the invention is not limited to the configurations of the first and the second embodiments. For example, the location information may be uploaded to a homepage of the corresponding office (i.e., “a Office”) such that any subject may check the location information. In the following, an illustration is given of a third embodiment. Note that the third embodiment is mainly described based on the difference between the third embodiment and the first or the second embodiment.

### Information Generating-Transmitting Process in Image Processing Apparatus

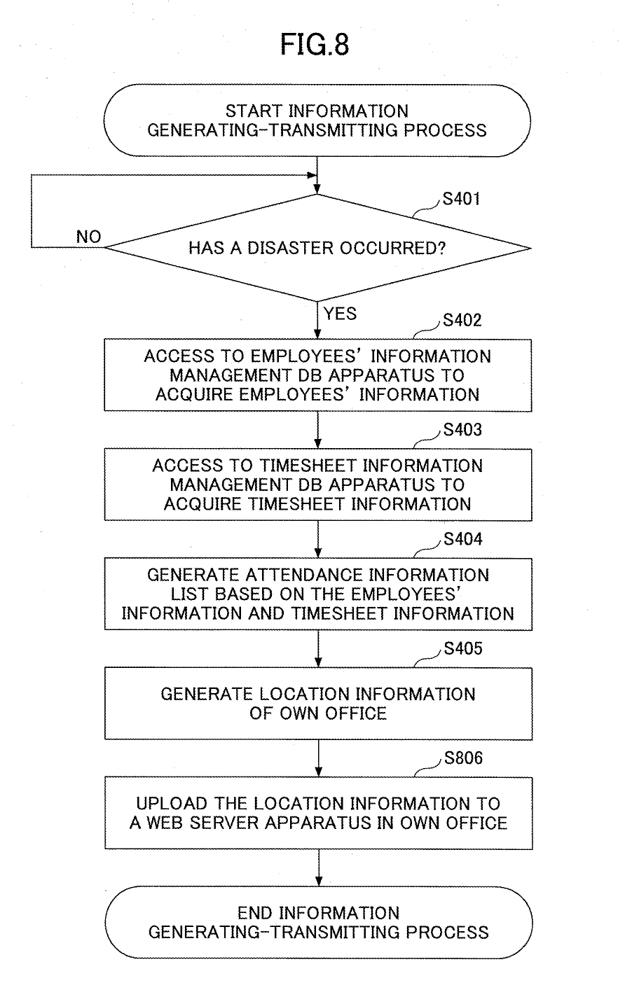

Illustration is given, with reference to FIG. 8, of an information generating-transmitting process of an image processing apparatus according to the third embodiment. FIG. 8 is another flowchart illustrating the information generating-transmitting process of the image processing apparatus 110. Note that steps S401 to S405 of the information generating-transmitting process in FIG. 8 are identical to steps S401 to S405 in FIG. 4, and the location information generated in step S405 is the same as the location information in FIG. 7. Hence, duplicated illustrations of those steps and location information are omitted.

As illustrated in FIG. 8, in step S806, the communications controller 116 uploads the location information generated in step S405 to the WEB server apparatus 151 in the “a Office”. Hence, the location information is posted on a homepage of the “a Office” provided by the WEB server apparatus 151. As a result, any subject may be able to perform safety confirmation by accessing the homepage.

### Fourth Embodiment

In the configurations of the first to the third embodiments, the subject that performs safety confirmation is assumed to manage the “a Office” as a whole. However, the invention is not limited to these configurations. For example, each administrator (manager) who presides over a corresponding one of floors of the “a Office” may be assumed to perform safe confirmation for the corresponding floor. In the following, an illustration is given of a fourth embodiment. Note that the fourth embodiment is mainly described based on the difference between the fourth embodiment and the first to the third embodiments.

### Information Generating-Transmitting Process in Image Processing Apparatus

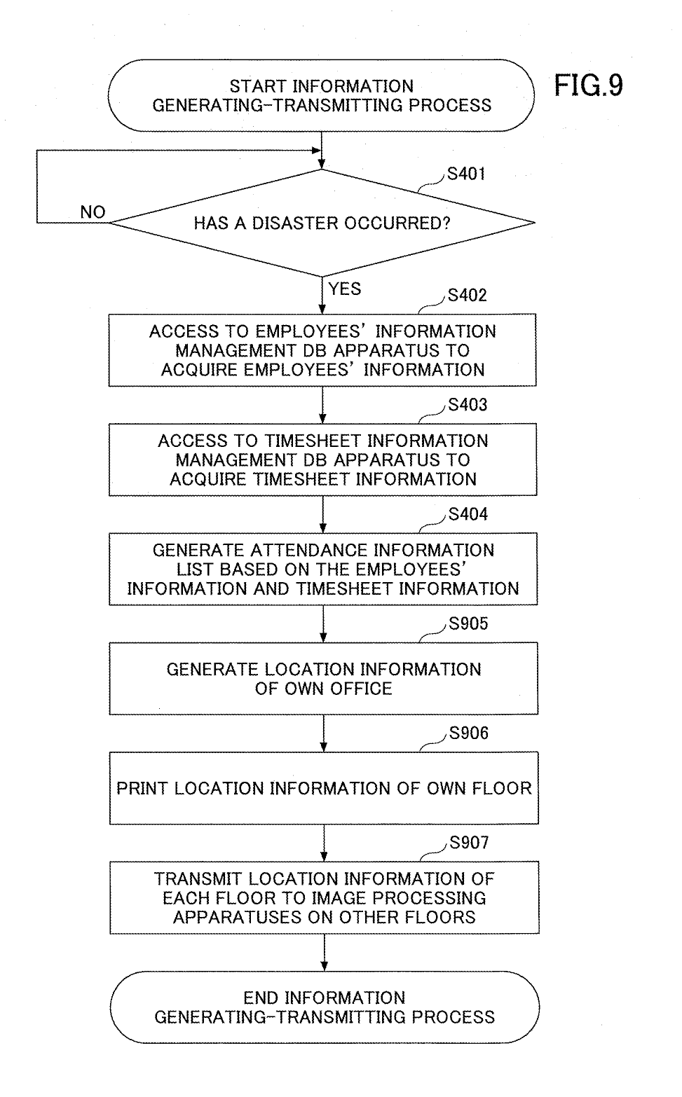

An illustration is given, with reference to FIG. 9, of an information generating-transmitting process of an image processing apparatus according to the fourth embodiment. FIG. 9 is another flowchart illustrating the information generating-transmitting process of the image processing apparatus 110. Note that steps S401 to S404 of the information generating-transmitting process in FIG. 9 are identical to steps S401 to S404 in FIG. 4. Hence, illustrations of those steps are omitted.

As illustrated in FIG. 9, in step S905, the information generator 114 generates location information of the own office for each of the floors based on the attendance information list generated in step S404. The image processing apparatus 110 according to the fourth embodiment is placed in “a Office”. Hence, when generating location information, the information generator 114 initially extracts employees who belong to “a Office” from the already generated attendance information list. Subsequently, the information generator 114 extracts the employees who actually stayed in the “a Office” at the occurrence of a disaster from the employees who belong to the “a Office”, which excludes the employees who had already departed from the “a Office” at the occurrence of the disaster. In addition, the information generator 114 generates location information of the employees who stayed in the “a Office” at the occurrence of the disaster by classifying the employees into respective floors where the employees stayed. That is, the information generator 114 classifies the employees who stayed in the “a Office” at the occurrence of the disaster in association with respective locations of the image processing apparatuses 110, 152, and 153 to generate location information of each classified employee.

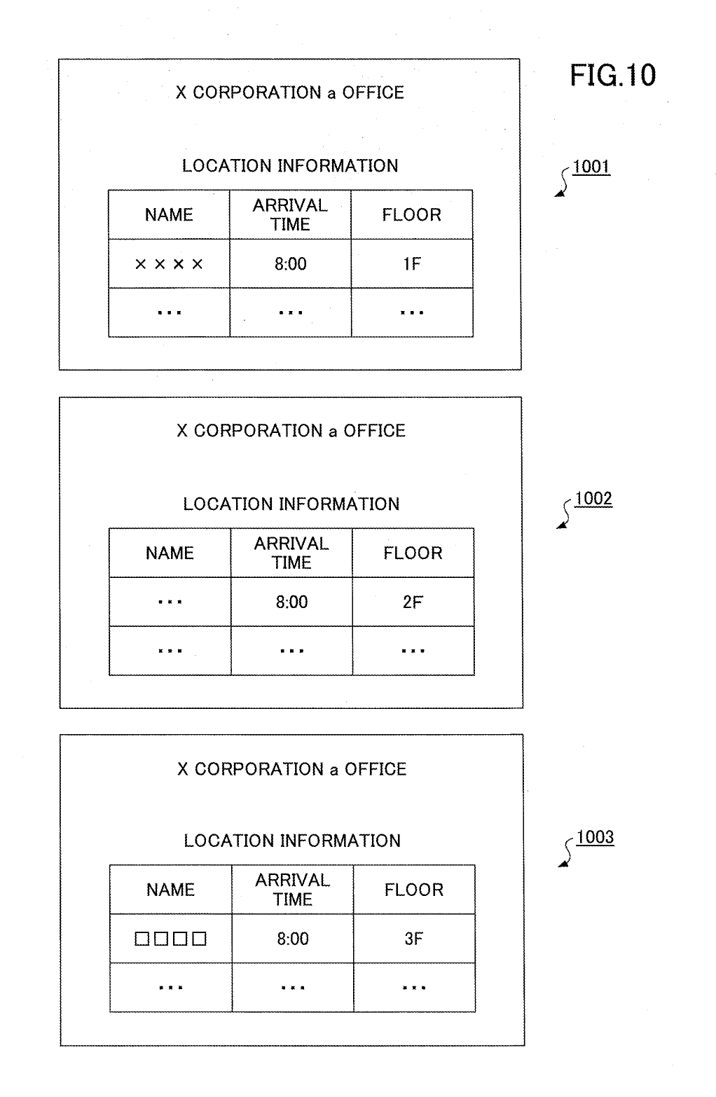

FIG. 10 is a diagram illustrating examples of location information that is generated in step S905. The location information 1001 illustrated in FIG. 10 is generated by extracting the employees who stayed on the first floor (1F) of the “a Office” at the occurrence of the disaster. Similarly, the location information 1002 is generated by extracting the employees who stayed on the second floor (2F) of the “a Office” at the occurrence of the disaster. Furthermore, the location information 1003 is generated by extracting the employees who stayed on the third floor (3F) of the “a Office” at the occurrence of the disaster.

Referring back to FIG. 9, in step S906, the location information 1001 is printed out on the own floor (i.e., this is because the image processing apparatus 110 according to the fourth embodiment is placed on the first floor (1F)). The location information 1001 lists the employees who stayed on the first floor of the “a Office” at the occurrence of a disaster. Hence, the administrator (manager) who presides over the first floor of the “a Office” may be able to confirm safety of the employees who stayed on the first floor of the “a Office” at the occurrence of the disaster based on the printed location information 1001.

In step S907, the communications controller 116 instructs the image processing apparatus 152 on another floor to print out the location information 1002 while transmitting the location information 1002 to the image processing apparatus 152. Similarly, the communications controller 116 instructs the image processing apparatus 153 on another floor to print out the location information 1003 while transmitting the location information 1003 to the image processing apparatus 153.

Hence, the administrator (manager) who presides over the second floor of the “a Office” may be able to confirm safety of the employees who stayed on the second floor of the “a Office” at the occurrence of the disaster based on the printed location information 1002. Further, the administrator (manager) who presides over the third floor of the “a Office” may be able to confirm safety of the employees who stayed on the third floor of the “a Office” at the occurrence of the disaster based on the printed location information 1003.

### SUMMARY

As described above, the image processing apparatus 110 according to the fourth embodiment is:
configured to include the disaster detector 112 to detect the occurrence of a disaster,
configured to access the employees' information management DB apparatus 130 and the timesheet information management DB apparatus 140 to initially generate the latest attendance information list and subsequently generate the location information for each floor of the own office, and
configured to automatically transmit the generated location information to the image processing apparatus on another floor of the office where the own apparatus is placed, and print out on the other floor the location information of the own floor and the location information of the other floor.

As described above, in the image processing apparatus 110 according to the fourth embodiment, it may be possible to generate the latest attendance information list by accessing the existing database apparatuses (the employees' information management DB apparatus 130 and the timesheet information management DB apparatus 140). Thus, unlike the related art system, there may be no need to dispose a dedicated sensor (i.e., a sensor for generating information for use in safety confirmation, e.g., a sensor to detect people's presence or absence or entering and leaving a room) in the image processing apparatus 110 according to the fourth embodiment. Hence, it may be possible to construct the image processing system having the image processing apparatus 110 according to the fourth embodiment at low cost.

Further, in the image processing apparatus 110 according to the fourth embodiment, the employees who belong to the own office and stay in the own office when a disaster has occurred are automatically extracted based on the generated attendance information list. Hence, it may be possible to reliably generate the location information in such a chaotic situation where a disaster has occurred. Moreover, the location information does not include information unnecessary for safety confirmation (e.g., the employees who belong to other offices, who do not belong to the own office when a disaster has occurred, or the employees on other floors). Hence, it may be possible to efficiently and reliably perform safety confirmation for each floor using the location information.

Further, in the image processing apparatus 110 according to the fourth embodiment, the image processing apparatus on each floor automatically prints out the generated location information of the corresponding floor. Hence, each administrator (manager) who presides over the corresponding floor will not fail to read the location information.

In summary, according to the fourth embodiment, it may be possible to construct a system that easily implements safety confirmation of disaster victims.

### Fifth Embodiment

In the configurations of the first to fourth embodiments, the power supply of the image processing apparatus 110 is not specifically mentioned. However, the image processing apparatus 110 may be operated by a commercial power supply or a battery power supply. Alternatively, the image processing apparatus 110 may usually be operated by a commercial power supply, and may be operated by switching the commercial power supply to a battery power supply after a disaster has occurred.

In the configurations of the first to the fourth embodiments, the image processing apparatus 110 is configured to include the disaster detector 112, the DB access controller 113, and the information generator 114. However, the configurations of the first to the fourth embodiments will not limit the scope of the present invention. For example, other devices or apparatuses in the image processing system 100 may be configured to serve as a part of or all of these functions of the image processing apparatus 110. In this case, the number of other devices or apparatuses may be one or more.

According to an aspect of the embodiments, it may be possible to construct a system that easily implements safety confirmation of disaster victims.

The present invention is not limited to the specifically disclosed the embodiments or combinations of the embodiments. Variations and modifications may be made without departing from the scope of the present invention.

The present application is based on Japanese Priority Application No. 2013-162297 filed on Aug. 5, 2013, the entire contents of which are hereby incorporated herein by reference.

What is claimed is:

1. An image processing system comprising:
an image processing apparatus configured to process an image;
a detector configured to detect occurrence of a disaster;
a first generator configured to generate information indicating locations of staff members belonging to an office where the image processing apparatus is placed when the detector has detected the occurrence of the disaster; and
a first transmitter configured to transmit the information indicating the locations generated by the first generator to a predetermined transmission destination according to the office.

2. The image processing system as claimed in claim 1, wherein
the first generator generates the information indicating the locations based on information indicating attributes of the staff members belonging to the office and information indicating timesheet data of the staff members belonging to the office.

3. The image processing system as claimed in claim 1, wherein
the first transmitter transmits the information indicting the locations to an image processing apparatus placed in an administrative agency that manages an area including the office as a transmission destination.

4. The image processing system as claimed in claim 1, wherein
the first transmitter transmits the information indicating the locations to a predetermined terminal connected via a local area network as a transmission destination.

5. The image processing system as claimed in claim 1, further comprising:
a second transmitter configured to upload the information indicating the locations generated by the first generator to a server apparatus that is accessible from the outside of the image processing system via an external network.

6. The image processing system as claimed in claim 1, further comprising:
a second generator configured to classify all the staff members belonging to the office in association with respective locations of a plurality of the image processing apparatuses placed in the office to generate information indicating a location of each of the classified staff members; and
a third transmitter configured to transmit the information indicating the location of the each of the classified staff members generated by the second generator to a corresponding one of the image processing apparatuses such that the transmitted information is printed out by the corresponding one of the image processing apparatuses.

7. A non-transitory recording medium storing a program having a set of instructions, which, when processed by a processor, causes a computer of an image processing apparatus to execute the program, the instructions comprising:
detecting occurrence of a disaster;
generating information indicating locations of staff members belonging to an office where the image processing apparatus is placed when the occurrence of the disaster is detected; and
transmitting the information indicating the locations generated by a first generator to a predetermined transmission destination according to the office.
